(19) United States
(12) Patent Application Publication
(10) Pub. No.: US 2023/0254407 A1
(43) Pub. Date: Aug. 10, 2023

(54) PRIORITY OF COMMUNICATION AND TEXT

(71) Applicant: KAUSHAL SHAH, EDISON, NJ (US)

(72) Inventor: KAUSHAL SHAH, EDISON, NJ (US)

(21) Appl. No.: 18/094,361

(22) Filed: Jan. 8, 2023

Related U.S. Application Data
(60) Provisional application No. 63/307,157, filed on Feb. 6, 2022.

(51) Int. Cl. H04M 3/436; H04M 3/533

(52) U.S. Cl. CPC H04M 3/4365; H04M 3/5335

(57) ABSTRACT

A method for employing a priority level for a call and text from a caller to a receiver is described. The method involves displaying a priority level selection choice to the caller on the screen of the call initiating device when the call is first placed. The method involves sending data from one mobile device to another receiving device in the form of a text message along with the corresponding priority indication.

### TECHNICAL FIELD OF THE INVENTION

The present invention generally relates to communication systems and methods, specifically indications for priority telephonic communication, including call and text message communication

### DESCRIPTION OF THE BACKGROUND ART

With standard smartphone functionality, a caller may place a call to another user (receiver). This standard or native call functionality may involve the caller entering the receiver telephone number, selecting the receiver's name from a list of contacts, or some other input function. In addition, this standard functionality may involve the receiver smartphone producing an indication of the incoming call as an alert to the receiver. This indication may be a ringtone, a visual indicator displayed on the screen, a vibration indicator, or some other indicator.

There might be instances when the caller is in an emergency and needs to reach the receiver as soon as possible. For that, the caller has to call multiple times. There might be instances when the user device is on silent mode, and he is unable to attend the call. The receiver may decide not to answer the incoming call after seeing the identity of the caller. The receiver may decide not to answer the incoming call without seeing the identity of the caller, such as when the smartphone is in his pocket, and he does not want to remove it. Thus, there exists a need to notify the receiver that there is an emergency and caller is trying to reach them on an urgent basis.

### SUMMARY

Embodiments relate to systems and methods for setting, validating, and indicating call and text message priority levels, and further handling calls and messages based on priority level.

According to an embodiment, a method is provided for making and indicating a priority level of a call or text message from a caller/sender to a receiver. The method includes receiving data corresponding to a priority level at a receiver mobile device from a caller mobile device. The data corresponding to the priority level may represent the priority level set by the caller at the time along with a text message indicating the nature of priority or emergency when the call was initiated by the caller. The method further includes providing an indication on the receiver's mobile device of the priority level at a time that the call is indicated to the receiver as incoming. When the receiver does not pick the call, the missed call along with the priority level and text message is indicated in the call logs of the receiver.

In some embodiments, the method further includes various ways of indicating the call priority level to the receiver. For example, indicating the call priority level may include presenting a particular indication on a screen of the receiver's mobile device that corresponds to the priority level. As another example, indicating the call priority level may include presenting a particular text or color background on the screen of the receiver mobile device that corresponds to the priority level. As another example, indicating the call priority level may include emitting a particular sound at the receiver mobile device that corresponds to the priority level. As another example, indicating the call priority level may include emitting a particular vibration pattern from the receiver mobile device that corresponds to the priority level.

In some embodiments, the procedure also includes switching the receiver mobile device from silent to non-silent mode to indicate the priority level.

In certain embodiments, the technique further includes performing one or more unique behaviours on the receiver mobile device in accordance with the priority level when the receiver answers the call.

According to an embodiment, a mobile device is provided for using a priority level for a call from a user of a second mobile device. The mobile device is set up to receive data corresponding to the priority level from the user of the second mobile device. When the user places the call to the second mobile device, the data relating to the priority level is presented like the priority level and a priority text message the caller had set at that time of making the call. When a call is detected as incoming on the second mobile device, the device may also be programmed to display a priority level indication.

In some embodiments, the mobile device may make numerous indications of the call priority level. For instance, displaying a color that matches the call priority level on the mobile device's screen might indicate the call priority level. As another example, a specific text that corresponds to the call priority level may be displayed on the mobile device's screen to indicate the call priority level. As another example, the mobile device may also make a specific sound that is associated with the priority level to indicate the call priority level. As another example, the mobile device may emit a specific vibration pattern that matches to the call priority level in order to indicate the call priority level.

In some embodiments, as a way of indicating the priority level, the mobile device may be set to go from silent to non-silent mode.

### DESCRIPTION

Embodiments relate to systems and methods for setting, validating, and indicating call and text message priority levels, and further handling them based on priority level.

The detailed description set forth below in connection with the appended drawings is intended as a description of various configurations and is not intended to represent the only configurations in which the concepts described herein may be practiced. The detailed description includes specific details to provide a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with “processing electronics” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In addition, one or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media include computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk, where disks usually reproduce data magnetically, while discs reproduce data optically with lasers. Combinations of the above should also be included within the scope of computer-readable media.

First, an example communication system according to conventional systems will be discussed. In this disclosure, a person initiating a call on an electronic communication network is referred to as a caller. A person receiving a call request from a caller is referred to as a receiver in this disclosure. A caller initiates a call to a receiver. The caller may use a caller mobile device, and the receiver may use a receiver mobile device. The call initiated by the caller and received as an incoming call by receiver is placed through a cellular network or other electronic communication network, to which both the caller mobile device and the receiver mobile device are connected. In other scenarios, the call may use different intermediate networks, such as multiple cellular networks or a cellular network and a local area network. The caller mobile device has a screen that indicates to the caller that the call has been initiated. The receiver mobile device has a screen that indicates to the receiver that an incoming call has been received from the caller. In some embodiments, the call may be a telephone call.

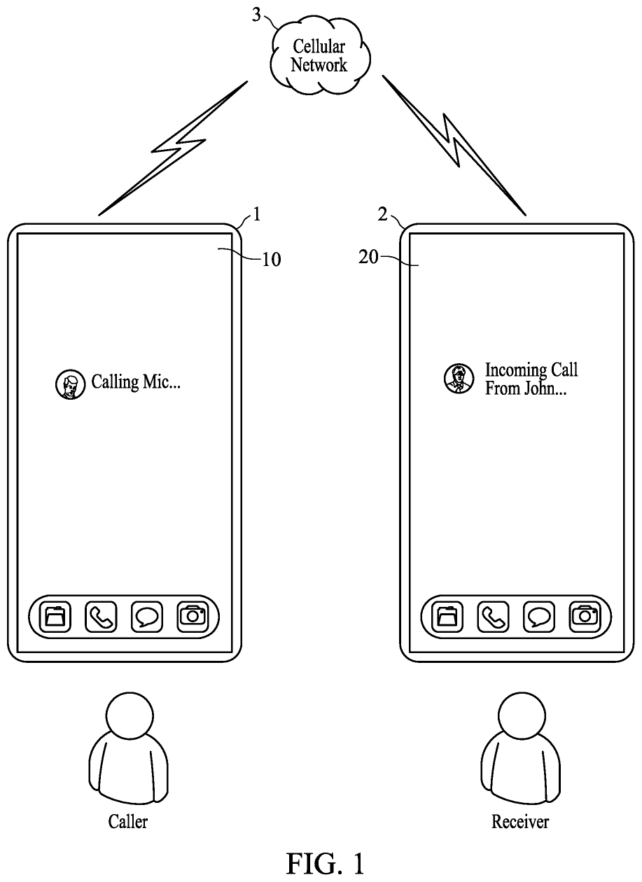

FIG. 1 is a diagram of a communication system according to various embodiments of the disclosure. FIG. 1 shows: a caller with a call initiating device 1 having a screen 10; a cellular network 3; and a receiver with a call receiving device 2 having a screen 20. The call initiating device 1 and call receiving device 2 may be any of a variety of devices capable of initiating and receiving calls, such as mobile telephone devices, cellular telephones, smartphones, tablet computers, laptop computers, etc.

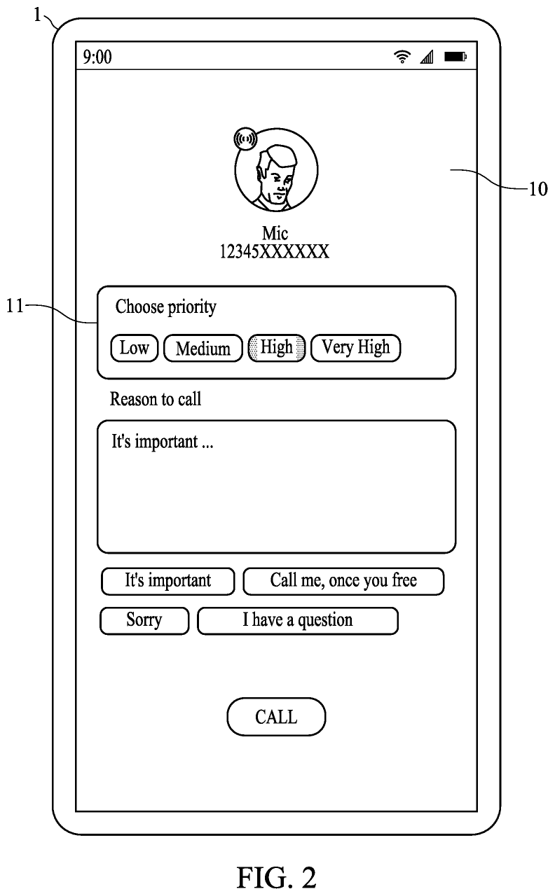

As shown in FIG. 2, the screen 10 shows the options to select before the caller makes a call. Screen 10 provides a priority selection area 11 that the caller can use to set a priority level for the call. The priority level can be selected as “low”, “medium”, “high” and “very high”. Along, the priority level, the caller adds text message notifying the receiver with reason of the corresponding priority level the text message can be selected from already available template messages or the caller can edit and write as the condition. For example, a “very high” priority along with a text “Car Accident” select a “high” priority case and indicates that the person is stuck somewhere and need some assistance, a “medium’ priority and indicates that a wife is reminding her husband to bring something for home, and a “low” priority with a text message to catch up later in the evening.

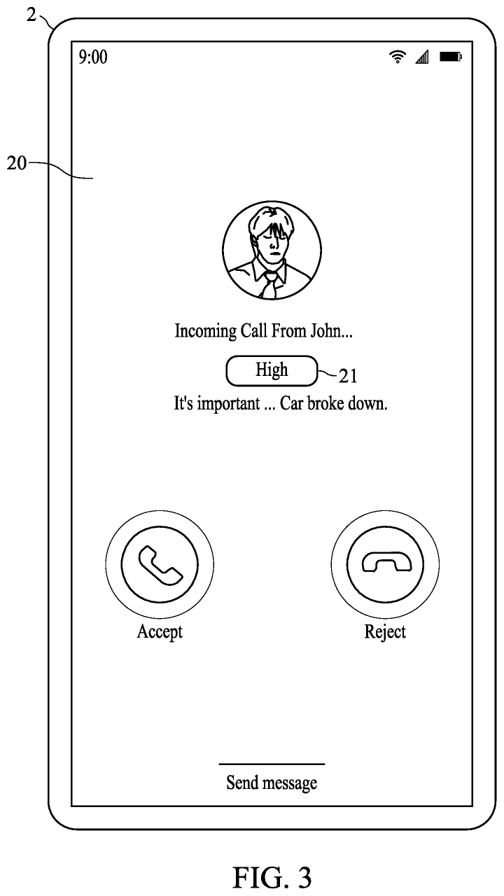

As, shown in FIG. 3, the screen 20 indicates to the receiver that an incoming call has been received from the caller. Screen 20 additionally provides a priority indication area 21 that indicates to the receiver the priority level along with the text message selected/written by the caller while making the incoming call. In the example of FIG. 2, the caller has selected a priority level using priority selection area 11 and text message corresponding to the priority level. The corresponding message for the high priority level is displayed to the receiver in priority indication area 21. The call initiated by the caller and received as an incoming call by receiver is placed through a cellular network 3, to which both the call initiating device 1 and the call receiving device 2 are connected. In other scenarios, the call may use different intermediate networks, such as multiple cellular networks or a cellular network and a local area network.

The use of priority selection area 11 allows the caller to set the priority level and add text message for the call using the same interface with which the call is initiated. Likewise, priority indication area 21 indicates to the receiver the priority level with the text message of the call using the same interface with which the incoming call details are displayed. In this way, both the caller and receiver have convenient access to the priority level for the call. In addition, because the priority level is displayed at the same time the incoming call details are displayed, the receiver will be sure to receive the priority level indication prior to or at the same time as receiving the incoming call. Finally, data corresponding to the priority level selected in priority selection area can be sent through the cellular network to the call receiving device 2 using a real-time transmission channel In this way, the receiver will always receive an indication of the selected priority level in priority indication area along with displaying the incoming call details. With these improvements, various embodiments of the disclosure allow convenient and effective setting and indication of call priority levels, allowing receivers of calls to make more informed decisions as to answering or ignoring incoming calls.

A variety of real-time transmission channels may be used to transmit data corresponding to the priority selected in priority selection area 11 through the cellular network to the call receiving device 2.

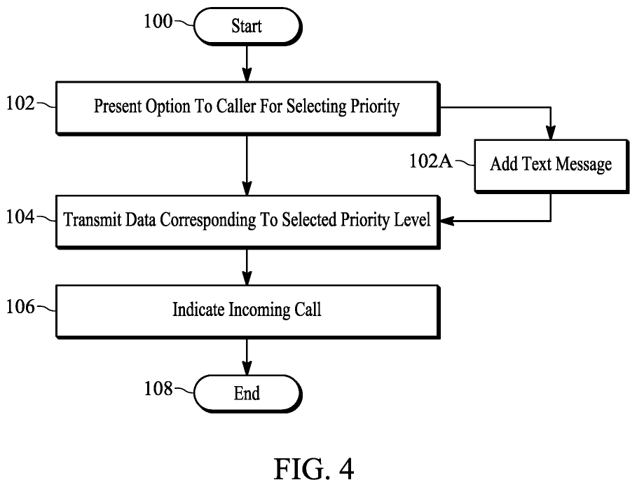

FIG. 4 is a flow chart of a process for setting and indicating call priority levels according to various embodiments of the disclosure. The process starts at step 100.

At step 102, the caller is given the option to choose the call's priority level. A priority selection area allows the caller to select the priority level. The priority levels available can be “low”, “medium”, “high”, and “very high”. Other methods for enabling priority level selection, like those previously mentioned in this disclosure, may be used. At step 102A, the caller may further write a text message indicating the reason of the priority along with the priority level.

At step 104, data corresponding to the priority level selected by the caller is transmitted from the caller's call initiating device 1, through the cellular network 3, and to the receiver call receiving device 2. This data is preferably transmitted as part of or concurrently with the messaging used to initiate the call, such as call setup messaging.

At block 106, the call receiving device 2 indicates to the receiver that an incoming call has been received and is of the selected priority level. As an example, the call receiving device 2 may display “Caller calling . . . HIGH PRIORITY!” along with a text message on the screen “IN ACCIDENT!! . . . GOING TO HOSPITAL!!” etc., on the screen 20 of the call receiving device 2. Any of the techniques described previously in this disclosure for indicating the priority level of an incoming call may be used.

The process ends at block 108, when the user accepts or reject the call after seeing the priority level.

In various embodiments of the present disclosure, a variety of approach may be used to allow the caller to select a priority level. For example, in the same window where a number pad for dialling a phone number is displayed on screen 10, priority selection area 11 might also be visible. The same interface used to enter a caller's phone number may be used by the caller to select the priority level in this method. Other priority level selection methods consistent with this disclosure are possible in various embodiments.

In various embodiments of the present disclosure, a variety of techniques may be used to indicate the priority level of an incoming call, notwithstanding how priority indication area 21 is shown in FIG. 1. According to the chosen priority level for the incoming call, for example, certain text characters may be displayed on screen 20, such as “HIGH PRIORITY!. Some examples of the text messages can be “IN ACCIDENT”, “INJURY!!!”, “AVAILABLE FOR A DRINK TONIGHT?”.

In various embodiments a special colour scheme that matches the selected priority level that may be shown on screen 21 or elsewhere on the call receiving device 2. An incoming call of high priority, for instance, can have a dark red background, an incoming call of normal priority can have a light red colour background, or an incoming call of low priority can have a yellow colour background. Priority text can also be indicated on the screen “Incoming Call from Caller . . . ”, along with the color background corresponding to the priority level, for e.g., showing red color background for high priority, orange for medium priority and purple for low priority, or any other color combination as selected by the receiver or caller as per their convenience.

In various embodiments call receiving device 2 will produce a specific audible tone to indicate the priority level that has been chosen. For instance, when an incoming call is of high priority, a loud buzzer sound may be played instead of the default ringtone.

In various embodiments the usage of a unique vibration pattern to indicate the priority level that has been chosen. As an instance, when an incoming call is of high priority, the call receiving device 2 may vibrate continuously rather than only occasionally.

In an alternate embodiment, the caller at the call initiating device may also have the option to share his/her real time location with the call receiving device along the call.

In various embodiments based on the selected priority level of the incoming call, call receiving device 2 may switch from a silent mode to a non-silent mode. For instance, if call receiving device 2 is set only to vibrate and present a visual indicator for an incoming call (but no audible indicator), call receiving device 2 may instead use all of a vibration indicator, a visual indicator, and an audible indicator if the incoming call is of high priority.

In some examples, call priority instructions may be effective in causing call receiving device 2 to communicate a call priority level associated with an incoming call to a user of call receiving device 2. For instance, call priority instructions may instruct touchscreen display and speaker to present information, such as visual text and a special tone, respectively, to the user (in this case, the receiver) of the call receiving device 2 that indicates the priority level selected by the caller, upon receiving data corresponding to a call priority.

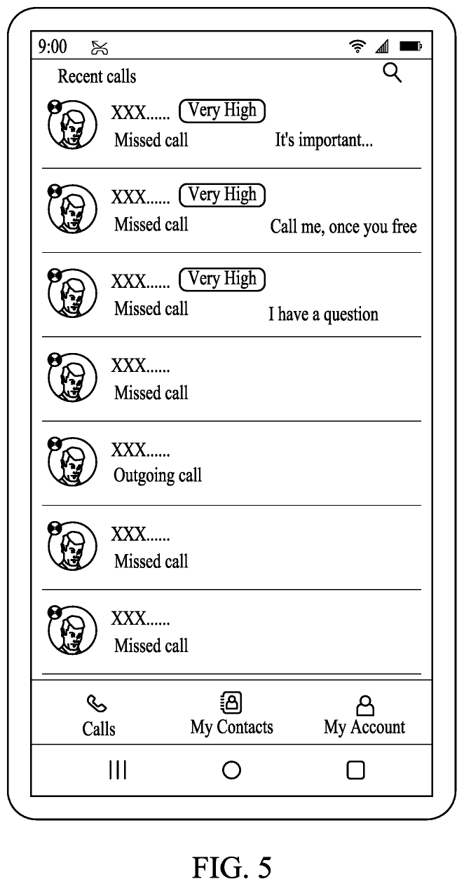

In further embodiment, as shown in FIG. 5, if a call is not picked by receiver due to some reason, the missed calls can be shown in the call logs with the priority level. The calls of very high priority can be shown on the top, irrespective of the time when the call was placed. The call logs can also show the text corresponding to the priority level. In another example the text message can be seen after selecting the detail option of the missed call.

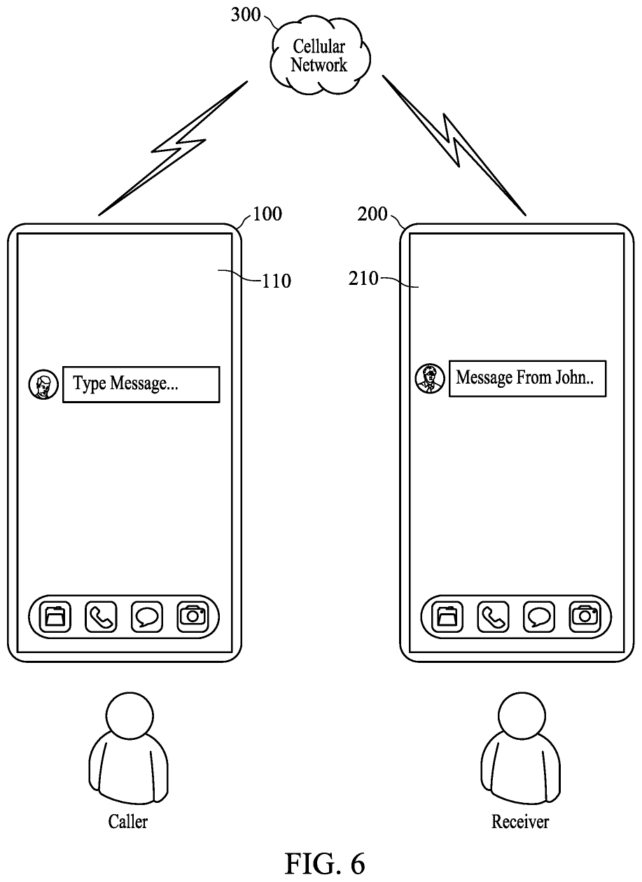

In another embodiment of the invention, the process includes a method of sending priority text messages along with a priority level associated with the priority text message. As shown in FIG. 6, a sender device 100 having a screen 110; a cellular network 300; and a receiver with a receiver device 200 having a screen 210. The sender device 100 and the receiver device may be various devices capable of initiating and receiving calls, such as mobile telephone devices, cellular telephones, smartphones, tablet computers, laptop computers, etc.

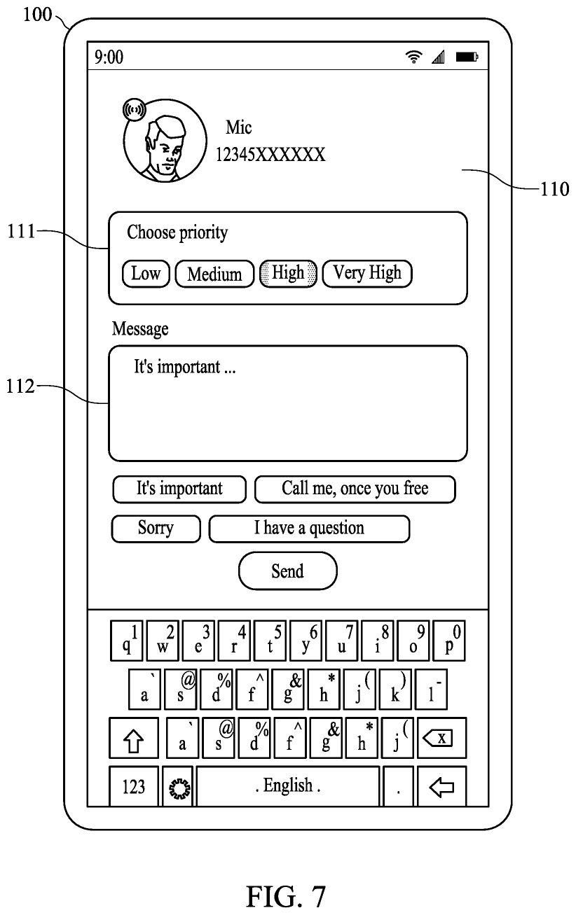

As shown in FIG. 7, the screen 110 of the sender device 100 comprises the option before sending a text to the receiver device 200. Screen 110 comprises a priority selection area 111, that the sender can use to set a priority level for the text. The priority level can be selected as “low”, “medium”, “high” and “very high”. The screen 110 further comprises a text inserting area 112, where a text related to the selected priority level can be inserted. The text message can selected from already available template messages or the user can edit and write as the condition. For example, a “very high” priority along with a text “car accident”, select a “high” priority case and indicates that the person is stuck somewhere and need some assistance, a “medium’ priority and indicates that the a wife reminding her husband to bring something for home, and a “low” priority with a text message to catch up later in the evening.

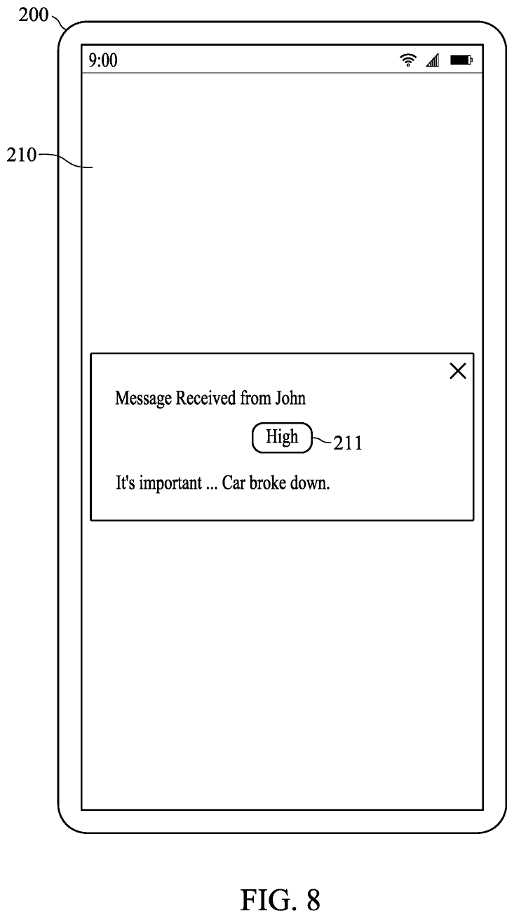

As shown in FIG. 8, the screen 210 indicated to the receiver device that a message has been received along with the priority level. The screen 210 comprises a priority indication area 211 that indicates to the receiver 200 the priority level along with the text message selected/written by the sender device 100. The text message sent by the sender device 100 is received by the receiver device 200 is through a cellular network 300, to which both the sender device 100 and receiver device 200 are connected. Different intermediate networks can also be used in other scenarios, such as multiple cellular networks or a cellular network and a local area network.

The use of priority selection area 111 allows the sender 100 to set the priority level and add text message. Likewise, priority indication area 211 indicates to the receiver 200 the priority level with the text message. In this way, both the sender and receiver have convenient access to the priority level for the text message. In addition, because the priority level is displayed at the same time that the text message details are displayed, the receiver will be sure to receive the priority level indication prior to or at the same time as receiving text message. With these improvements, various embodiments of the disclosure allow convenient and effective setting and indication of call priority levels, allowing receivers of calls to make more informed decisions as to answering or ignoring incoming calls.

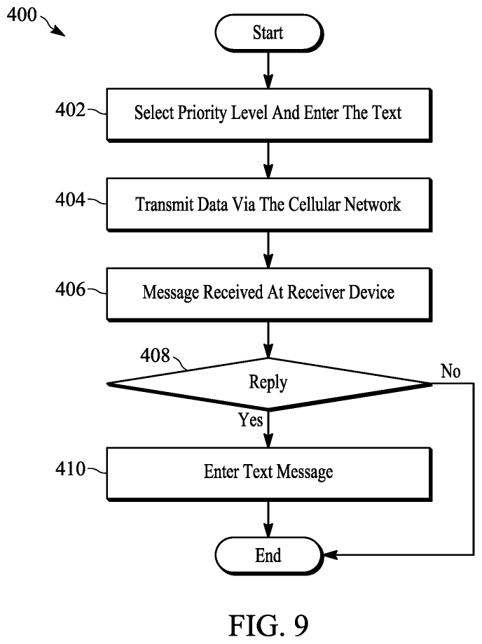

FIG. 9 is a flow chart of a process of sending a text message with a priority level.

At step 402, the user of the sender device 100 is given the option to choose the priority level from the priority selecting area 111. The priority levels available can be “low”, “medium”, “high”, and “very high”. Other methods for enabling priority level selection, like those previously mentioned in this disclosure, may be used. After selecting the priority level, the sender inputs the text message in the text inserting area 112.

At step 404, information regarding, the priority level selected by the sender device 100 is transmitted, through the cellular network 300, and to the receiver device 200.

At step 406, the receiver device 200 indicates to the user than a text message has been received and is of a selected priority level.

At step 408, the user of the receiver device 200, has an option of replying to the message, or not replying.

The receiver at receiving device enter the text to reply at step 410, and the process ends

In various embodiments a special colour scheme that matches the selected priority level that may be shown on screen 210 or elsewhere on the receiver device 200. A text message of high priority, for instance, can have a dark red background, a text message of normal priority can have a light red colour background, or a text message of low priority can have a yellow colour background.

In various embodiments the receiver device 200 will produce a specific audible tone to indicate the priority level that has been chosen. For instance, when a text message is of high priority, a loud notifying sound may be played instead of the default ringtone.

In various embodiments the usage of a unique vibration pattern to indicate the priority level that has been chosen. For instance, when a text message is of high priority, the call receiver device 2 may vibrate frequently rather than only occasionally.

In various embodiments based on the selected priority level of the text message, receiver device 200 may switch from a silent mode to a non-silent mode. For instance, if receiver device 200 is set to only to vibrate and present a visual indicator for a text message (but no audible indicator), receiver device 200 may instead use all of a vibration indicator, a visual indicator, and an audible indicator if the text message is of high priority.

In further embodiments, if the text message is not seen the user of the receiver device 200, the message is placed on top in the notification area and in the inbox, irrespective of the time when the text message was received.

In an alternate embodiment, the sender may also have the option to share his/her real time location with the receiving device along with the text message.

The previous description enables any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality is implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

I/We claim:

1. A method of making a priority telephonic call on a communication network, the method comprises the steps of:
a. selecting a call priority level on a call initiating device;
b. selecting a text message corresponding to the call priority;
c. initiating the call via the communication network; and,
d. indicating a call priority and related text to a call receiving device;
wherein a receiver at the call receiver device accepts or rejects the call after seeing the call priority and the corresponding text message.

2. The method as claimed in claim 1, wherein the call initiating device comprises a screen having a priority selection area and a text inserting area while making a call to the call receiving device.

3. The method as claimed in claim 1, the priority level can be selected from “low”, “medium”, “high”, “very high”.

4. The method as claimed in claim 1, wherein the indication of the priority comprises changing the call receiving device from a silent mode to a non-silent mode.

5. The method as claimed in claim 1, wherein the indication of the priority level comprises displaying text that corresponds to the priority level on a screen of the call receiving device.

6. The method as claimed in claim 1, wherein the indication of the priority level comprises displaying a color that corresponds to the priority level on the screen of the call receiving device.

7. The method as claimed in claim 1, wherein the indication of the priority level comprises emitting an audible tone that corresponds to the priority level from the call receiving device.

8. The method as claimed in claim 1, wherein the call initiating device may also share the real time location with the call receiving device.

9. A method of sending a priority text on a communication network, the method comprises the steps of:
a. selecting a priority level of the text from a preselected template on a sender device;
b. entering a text corresponding to the priority;
c. sending the text via the communication network; and,
d. indicating the priority level and related text to a receiving device.

10. The method as claim in claim 9, the priority level can be from one of following: “low”, “medium”, “high”, “very high”.

11. The method as claimed in claim 9, wherein the indication of the priority level comprises changing the receiving device from a silent mode to a non-silent mode.

12. The method as claimed in claim 9, wherein the indication of the priority level comprises displaying text that corresponds to the priority level on a screen of the receiving device.

13. The method as claimed in claim 9, wherein the indication of the priority level comprises displaying a color that corresponds to the priority level on the screen of the receiving device.

14. The method as claimed in claim 9, wherein the sender device shares the real time location with the receiver device.
